(19) United States
(12) Patent Application Publication
(10) Pub. No.: US 2001/0050745 A1
(43) Pub. Date: Dec. 13, 2001

(54) In-plane switching liquid crystal displaying device and method of fabricating the same

(76) Inventors: Biing-Der Liu, Taipei (TW); Ya-Hsiang Tai, Taipei (TW)

Correspondence Address: BIRCH STEWART KOLASCH & BIRCH, PO BOX 747, FALLS CHURCH, VA, 22040-0747, US

(21) Appl. No.: 09/848,349

(22) Filed: May 4, 2001

(30) Foreign Application Priority Data
Jun. 7, 2000 (TW) 89111097

(51) Int. Cl. G02F 1/136

(52) U.S. Cl. 349/141

(57) ABSTRACT

An in-plane switching liquid crystal displaying device comprises a common electrode main line; a plurality of common electrodes connecting to the common electrode main line; a pixel electrode main line; a plurality of pixel electrodes connecting to the pixel electrode main line and overlapping the common electrodes; and a isolation layer disposed between the common electrodes and the pixel electrodes. The storage capacitance of the pixel device can be increased by using the additional capacitance generated from the overlaps of the pixel electrodes and the common electrodes. Therefore, the area required by the storage capacitor could be reduced to increase the aperture ratio. In addition, the present invention can be carried out with almost no increase in cost.

### BACKGROUND OF THE INVENTION

1. Field of the Invention

The present invention relates to a liquid crystal display (hereinafter referred to as LCD). More particularly, it relates to some improvements on the aperture ratio of an in-plane switching (IPS) LCD.

2. Description of the Related Art

A conventional liquid crystal displaying devices is mainly fabricated by using twisted-nematic (TN) LCD. The TN LCD has two glass substrates disposed in parallel and liquid crystal molecular material filled between the two glass substrates. A plurality of pixel electrodes are arranged on the first glass substrate and a common electrode is arranged on the second glass substrate. The electric field distribution between the two glass substrates is controlled via voltages so as to control the directions of the molecules, thereby controlling the displays of all corresponding pixels. However, the conventional TN LCD is subjected to a drawback of a too narrow view-angle. Therefore, IPS LCDs have been developed.

In an IPS LCD, pixel electrodes and common electrodes are disposed on the same glass substrate; color filters and black matrixes are disposed on the other glass substrate. FIG. 1 shows the plane layout of a conventional IPS LCD. FIG. 2 shows the cross-sectional view of FIG. 1 along the line II-II′. FIG. 3 shows the cross-sectional view of FIG. 1 along the line III-III′. What is depicted in FIGS. 1, 2, and 3 only shows a portion of circuitry arranged on a glass substrate with pixel electrodes and common electrodes, not showing the other glass substrate and the liquid crystal molecular layers.

The fabricating process and structure of the conventional IPS LCD are described hereinafter in view of FIGS. 1 , 2, and 3. First, a gate line 110 and a common electrode structure are provided on a glass substrate 100, wherein the common electrode structure comprises common electrode main lines 120 in parallel to the gate line 110 and the common electrodes 121, 122, and 123 connected between the common electrode main lines 120. An isolation layer 130 is formed over the gate line 110, common electrode main lines 120, the common electrodes 121, 122, and 123. Then, a data line 140 and a pixel electrode structure are formed. The pixel electrode structure comprises (1) pixel electrode main lines 143 and 144 formed over the common electrode main lines 120 and (2) pixel electrodes 145 and 146 interlaced in parallel with the common electrodes 121, 122, and 123.

The extended segment 141 of the data line 140 and the extended segment 142 of the pixel electrode main line 143 serve as the drain and source of a thin film transistor (TFT) respectively, and work in conjunction with the gate line 110 below them to form a control TFT 101 for controlling the displaying of the pixel. Moreover, pixel electrodes 143 and 144 overlap the common electrode main lines 120 with the isolation layer 130 formed therebetween, thereby forming the storage capacitor of the control TFT 101 at source terminal. In order to increase the capacitance of the storage capacitor, the overlapping portion of the pixel electrode 143 (and 144) and the electrode main lines 120 should be increased. However, the areas of the pixel electrode 143, 144 and the common electrode main line 120 must be well controlled so as to get an appropriate aperture ratio of the pixel device.

Referring to FIG. 1, the open regions S of the pixel device is determined by common electrode main lines 120, common electrodes 121, 122, and 123, pixel electrode main lines 143 and 144, and pixel electrodes 145 and 146. Consequently, if the areas of the common electrode main lines 120 and the pixel electrode main lines 143 and 144 are increased to obtain greater capacitance of the storage capacitor, then the areas of the open regions S will be decreased and the brightness of the pixel device will become lower. This problem is one drawback of the conventional IPS LCD.

### SUMMARY OF THE INVENTION

Therefore, an object of the present invention is to provide an IPS LCD and a method to fabricate the same. The capacitance of the storage capacitor can be effectively increased without affecting the present aperture ratio of pixel devices and varying the present fabricating process. Furthermore, the areas of the common electrodes and pixel electrodes can be reduced so as to obtain high aperture ratio of the pixel devices.

The present invention achieves the above-indicated objects by providing an in-plane switching liquid crystal displaying device, which at least has one pixel device. The pixel device comprises a common electrode main line; at least one common electrode connected with the common electrode main line; a pixel electrode main line; at least one pixel electrode connected with the pixel electrode main line and overlapping the common electrode; and a isolation layer disposed between the common electrode and the pixel electrode. The overlap of the pixel electrode and the common electrode can serve as storage capacitors, therefore increasing the capacitance of the storage capacitor on the pixel device. In addition, because the overlap of the pixel electrode and the common electrode have provided a portion of the capacitance of the storage capacitor, therefore the required area of the pixel electrode main line can be considerably reduced, thereby increasing the aperture ratio of the pixel device. On the other hand, the pixel device is surrounded by data lines and a gate line which work in conjunction with the pixel electrode main line to constituting a control thin film transistor for the displaying of the pixel device.

In a practical arrangement, the common electrode main line can be disposed along a first direction. These common electrodes are disposed in parallel along a second direction (vertical to the first direction), showing the type of fingers. These common electrodes comprise the common electrodes formed in original structure and the common electrodes formed on the predetermined positions of the pixel electrodes. The pixel electrode main line runs along the first direction and lays over the common electrode main line to provide a portion of storage capacitance. The pixel electrodes run in parallel along the second direction and lay over a portion of the common electrodes formed on the predetermined positions of the pixel electrodes. To avoid reducing the area of the open regions, the common electrodes formed on the predetermined positions of the pixel electrodes had better be smaller than the pixel electrodes formed above; that is, let the pixel electrodes completely cover the additional common electrodes. Because the pixel electrodes are not transparent, the additional common electrodes will not affect the aperture ratio of the pixel device.

In addition, the present invention provides a method for fabricating the in-plane switching liquid crystal displaying device mentioned above. First, a substrate is provided. Second, a common electrode main line and a plurality of common electrodes connected with the common electrode main line are formed on the substrate; a gate line also can be formed in this step. It is noted that the additional common electrodes are formed on the predetermined positions of the pixel electrodes, and when the pixel electrodes are formed sequentially, the pixel electrodes automatically lay over the common electrodes. Then, an isolation layer is formed over the common electrode main line and common electrodes. Finally, a pixel electrode main line and at least one pixel electrode connected with the pixel electrode main line are formed on the isolation layer; data lines also can be formed in this step. Consequently, these pixel electrodes will automatically overlap the common electrodes, thereby forming storage capacitors. If the areas of the pixel electrodes are large enough to completely cover the area of the common electrodes, then the aperture ratio of the pixel device is not affected. Moreover, the areas of the common electrode main line and pixel electrode main line can be further reduced to increase the aperture ratio. In this fabricating method, the additional common electrodes can be formed or carried out together with the conventional fabricating method, therefore not changing the original fabricating steps.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows the plane layout of a conventional in-plane switching liquid crystal displaying device;

FIG. 2 shows the cross-sectional view of FIG. 1 along the line II-II′;

FIG. 3 shows the cross-sectional view of FIG. 1 along the line III-III′;

FIG. 4 shows the plane layout of an in-plane switching liquid crystal displaying device according to the first embodiment of the present invention;

FIG. 5 shows the cross-sectional view of FIG. 4 along the line V-V′;

FIG. 6 shows a schematic circuit diagram of a single pixel device in the first embodiment of the preset invention;

FIG. 7 shows the fabricating process of the in-plane switching liquid crystal displaying device in the first embodiment of the present invention, especially the process steps for dealing with the glass substrate with common electrodes and pixel electrodes;

FIG. 8 shows the plane layout of an in-plane switching liquid crystal displaying device according to the second embodiment of the present invention.

### DETAILED DESCRIPTION OF THE PREFERRED EMBODIMENTS

The IPS LCD of the present invention utilizes additional common electrodes overlapping pixel electrodes, thereby increasing the storage capacitance. The area of the pixel electrode main line and the common electrode main line for providing the storage capacitor can be reduced correspondingly, therefore improving the aperture ratio and the display brightness. In the fabricating method, additional common electrodes and the original common electrodes can be formed in the same step without increasing additional masks, hence saving fabricating cost. The embodiments of the present invention will be described hereinafter in conjunction with the accompanying drawings.

First Embodiment

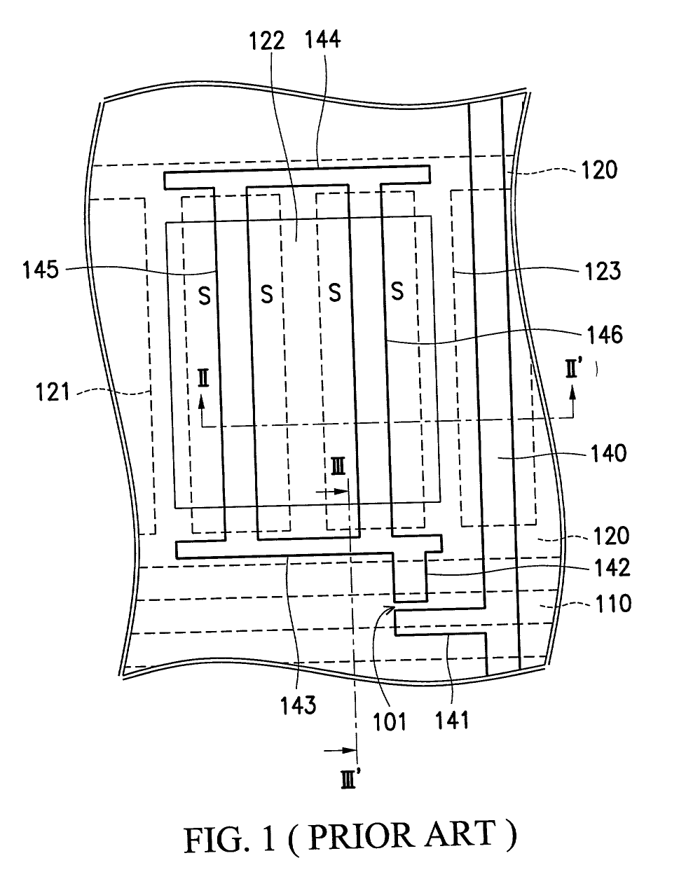

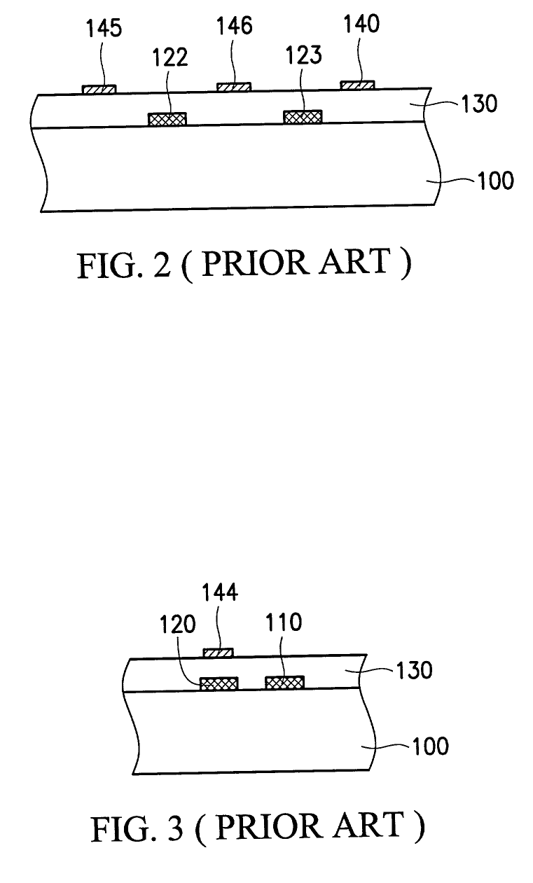

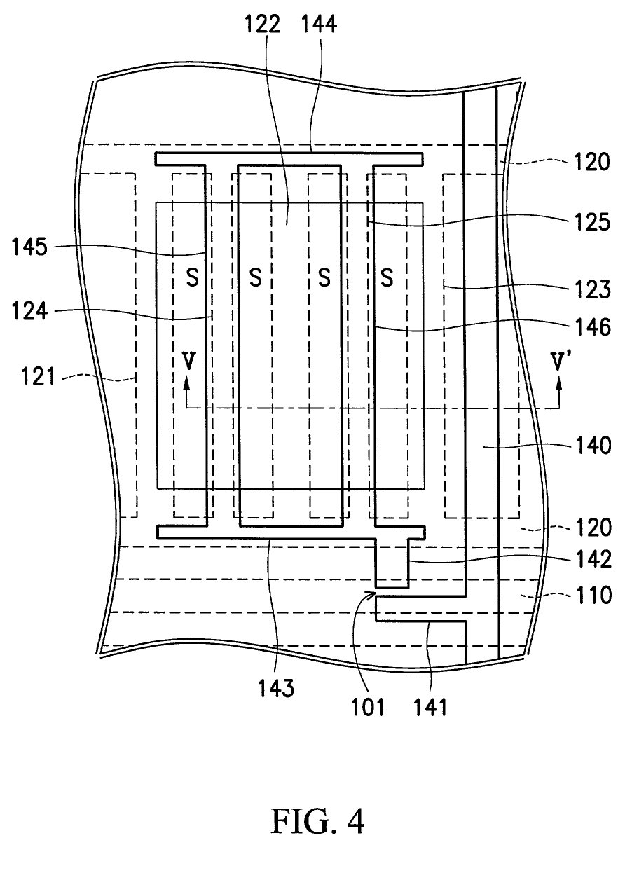

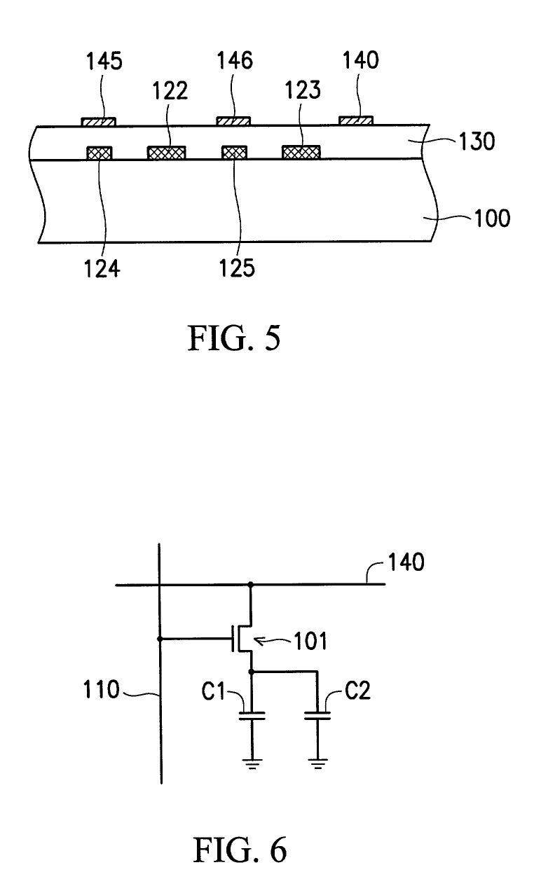

FIG. 4 shows the plane layout of an in-plane switching liquid crystal displaying device according to the first embodiment of the present invention; and FIG. 5 shows the cross-sectional view of FIG. 4 along the line V-V′. What is depicted in FIGS. 4, and 5 only show a portion of circuitry arranged on a glass substrate with pixel electrodes and common electrodes, not showing the other glass substrate and the liquid crystal molecular layers. In addition, the same devices and elements in FIGS. 1 to 3 are represented in the same notations and numerals.

Referring to FIGS. 4 and 5, the structure of the IPS LCD device in the first embodiment is similar to that of the conventional IPS LCD device. For example, the extended segment 141 of the data line 140 and the extended segment 142 in the pixel electrode structure serve as the drain and source of the control TFT 101; the gate line serves as the gate of the control TFT 101; and the isolation layer 130 are formed between the pixel electrode structure and the common electrode structure.

The main difference between the IPS LCD device of this embodiment and the conventional IPS LCD device is the common electrode structure. As depicted in FIG. 4, the common electrode structure comprises not only the common electrode main line 120, common electrodes 121, 122, and 123, but also a common electrode 124 and a common electrode 126. The common electrode 124 is disposed between the common electrode 121 and 122, connected to the common electrode main line 120 and covered by the pixel electrode 145. The common electrode 126 is disposed between the common electrode 122 and 123, connected to the common electrode main line 120 and covered by the pixel electrode 146. As shown in FIG. 4, the additional common electrodes 124 and 125 are completely covered by the pixel electrodes 145 and 146. Because the pixel electrodes 145 and 146 are not transparent regions, therefore the additional common electrodes 124 and 125 will not reduce the area of the open region S. Moreover, the additional common electrodes 124 and 125 and the pixel electrodes 145 and 146 can constitute the storage capacitor of the control TFT 101, the same case as the common electrode main line 120 to the pixel electrode main lines 143 and 144 described above. In other words, another type of storage capacitance of the pixel device is increased.

FIG. 6 shows a schematic circuit diagram of a single pixel device in the first embodiment of the preset invention; it also shows the equivalent circuit structure of this embodiment. As depicted in FIG. 6, the gate and drain of the TFT 101 are connected to the gate line 110 and the data line 140; the source of the TFT 101 is connected to the storage capacitor composed of the pixel electrode structure and the common electrode structure. The notation C1 represents the equivalent capacitor composed of the common electrode main line 120 and the pixel electrode main lines 143 and 144; the notation C2 represents the equivalent capacitor composed of the additional common electrodes 124, 125 and the pixel electrode main lines 143, 144. Provided that the required capacitance of the storage capacitor in the TFT 101 is fixed. Because the equivalent capacitor C2 is added in the first embodiment, therefore the capacitance of the equivalent capacitor C1 can be reduced. Reducing the capacitance of the equivalent capacitor C1 means that the overlap area between the common electrode main line 120 and the pixel electrode main lines 143 and 144 can be reduced. Consequently, as shown in FIG. 4, the common electrode main line 120 and the pixel electrode main lines 143 and 144 can shrink upward or downward so as to increase the area of the open region S, thereby improving the aperture ratio and the brightness.

On the other hand, after carrying out accurate electric field simulation to the IPS LCD device in this embodiment, one can find that adding common electrodes 124 and 125 under the pixel electrodes 145 and 146 will only change the distribution of the electric field beneath the pixel electrodes 145 and 146, not affecting the distribution of the electric field in the other open region S; but it is noted that the pixel electrodes 145 and 146 originally are not transparent regions. Consequently, the electric field distribution and the light transparency of the IPS LCD device according to the first embodiment of the present invention will not be changed or affected.

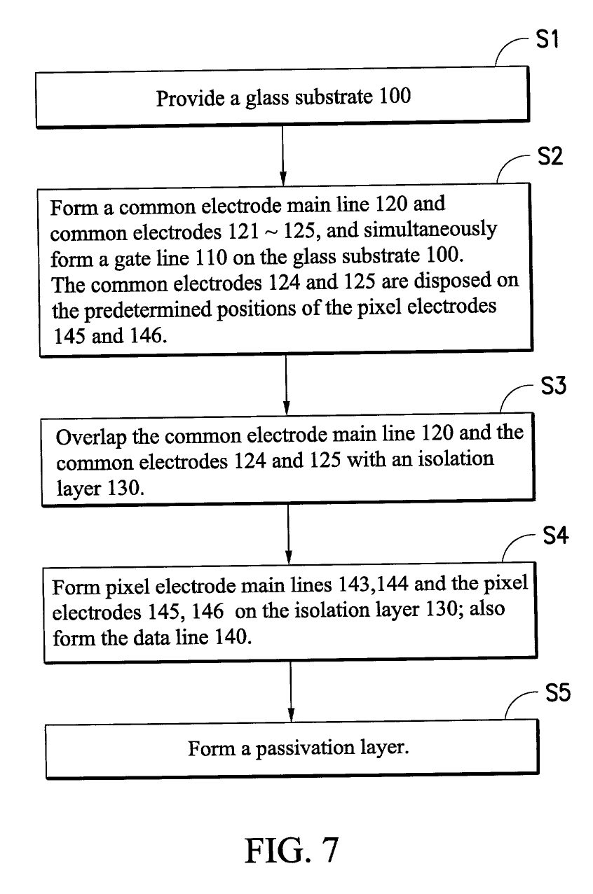

FIG. 7 shows the fabricating process of the in-plane switching liquid crystal displaying device in the first embodiment of the present invention. One advantage of the first embodiment is that the original steps of the process for fabricating the conventional IPS LCD device need not be considerably modified for fabricating the IPS LCD device of this embodiment, therefore increasing hardly any cost. First (step_1: S1), a glass substrate 100 is provided. Second (step_2: S2), a common electrode main line 120 and common electrodes 121˜125 connected to the common electrode main line 120 are formed on the glass substrate 100; also a gate line 110 can be formed simultaneously in this step. The additional common electrodes 124 and 125 are disposed on the predetermined positions of the pixel electrodes 145 and 146. Therefore, when the pixel electrodes are formed sequentially, they will automatically lay over the common electrodes 124 and 125. Then (step_3: S3), an isolation layer 130 is formed over the common electrode main line 120 and the common electrodes 124 and 125. Next (step_4: S4), pixel electrode main lines 143 and 144 ,and the pixel electrodes 145 and 146 connected to the pixel electrode main lines 143 and 144 are formed over the isolation layer 130; also the data line 140 can be formed in this step. Consequently, the pixel electrodes 145 and 146 will automatically lap over the additional common electrodes 124 and 125, thereby constituting the required storage capacitor. If the area of the pixel electrodes 145 and 146 are large enough to completely cover the common electrodes 124 and 125, then the aperture ratio will not be affected. Due to generating additional storage capacitance, the area of the common electrode main line 120 and the pixel electrode main lines 143 and 144 can be reduced so as to increase the aperture ratio. Finally (step_5: S5), a passivation layer is formed and the process done to the glass substrate is completed. The conditions for carrying out all steps of the above fabricating process are identical to that of the conventional fabricating process. The only difference is that common electrodes 124 and 125 must be formed on the predetermined positions of the pixel electrodes 145 and 146, when carrying out the step of forming the common electrode main line 120 and common electrodes 121˜125 via photolithography process. Accordingly, additional common electrodes can be carried out in conjunction with the conventional (original) process without modifying the procedures of the original fabricating process.

Second Embodiment

In the first embodiment, common electrodes 121˜125 are vertically connected to the common electrode main line 120; the pixel electrodes 145 and 146 also vertically connected to the pixel electrode main lines 143 and 144; and all these electrodes arrange in the shape of straight fingers. However, it is to be understood that the invention is not limited by features of the arrangement. The present invention also can be applied to the situation in which common electrodes (or pixel electrodes) are curve-shaped, or not vertically connected to the common electrode main line (or the pixel electrode main line).

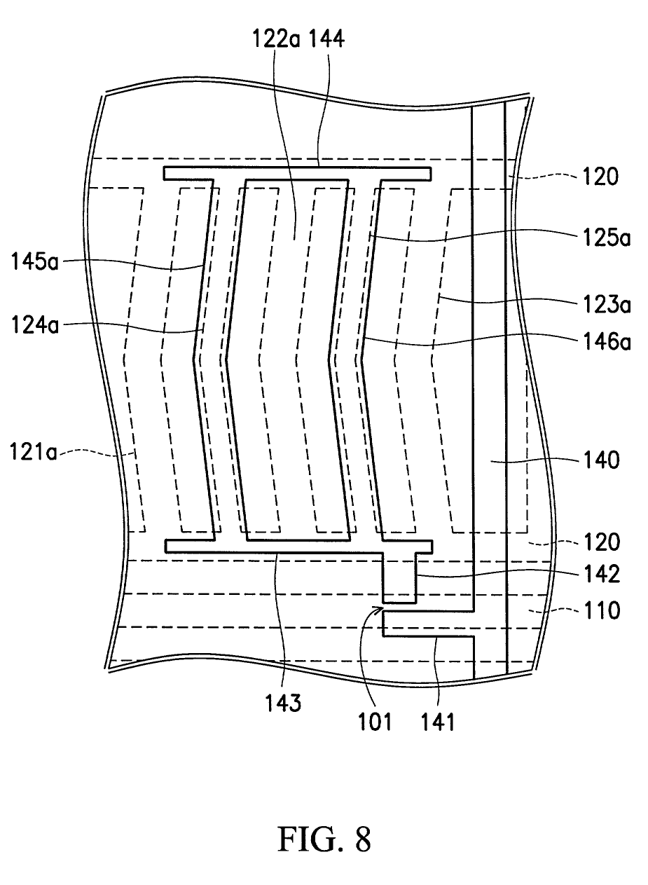

FIG. 8 shows the plane layout of an in-plane switching liquid crystal displaying device according to the second embodiment of the present invention. The main difference between FIG. 8 and the first embodiment in FIG. 4 is that the common electrodes 121a˜125a, and the pixel electrodes 145a and 146a are curve-shaped; and not vertically connected to the common electrode main line 120 and the pixel electrode main lines 143 and 144. In this case, common electrodes 124a and 125a still can be disposed under the pixel electrodes 145a and 146a so as to achieve the same object and performance as mentioned in the first embodiment.

To sum up, the IPS LCD of the present invention has the following features and advantages:

(1) Additional common electrodes are formed on the predetermined positions of the pixel electrodes, and the additional capacitance contributed by the common electrodes and the pixel electrodes can replace a portion of the original storage capacitance; whereby the aperture ratio is increased and the display brightness is improved. On the other hand, the additional common electrodes are disposed beneath the pixel electrodes, and therefore the aperture ratio and the distribution of the electric field in the open regions are not affected.

(2) The present invention can be carried out with almost no increase in cost, by merely modifying the photolithography process to generate additional common electrodes; and is available for the industry.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An in-plane switching liquid crystal displaying device having at least one pixel device, said pixel device comprising:
a common electrode main line;
at least one common electrode connecting to said common electrode main line;
a pixel electrode main line;
at least one pixel electrode connecting to said pixel electrode main line and overlapping said common electrode; and
an isolation layer disposed between said common electrode and said pixel electrode.

2. The device as claimed in claim 1, wherein said pixel electrode main line lays over said common electrode main line, and said isolation layer is disposed between said pixel electrode main line and said common electrode main line.

3. The device as claimed in claim 1, further comprising at least one data line and one gate line associated with said pixel electrode main line to constitute a thin film transistor of said pixel device.

4. The device as claimed in claim 1, wherein said common electrode main line is arranged along a first direction; said common electrode is arranged along a second direction not parallel with said first direction; said pixel electrode main line is arranged along said first direction and lays over said common electrode main line; said pixel electrode is arranged in parallel along said second direction and lays over said common electrode.

5. The device as claimed in claim 1, wherein the area of every said pixel electrode is greater than that of every said common electrode covered by said pixel electrode.

6. The device as claimed in claim 1, wherein said pixel electrode and common electrode are curve-shaped.

7. A method of fabricating an in-plane switching liquid crystal displaying device comprising the steps of:
providing a substrate;
forming on said substrate a common electrode main line and a plurality of common electrodes connecting to said common electrode main line;
forming an isolation layer over said common electrode main line and said common electrodes; and
forming on said isolation layer a pixel electrode main line and at least one pixel electrode connecting to said pixel electrode main line; wherein said pixel electrode lays over said common electrodes.

8. The method as claimed in claim 7, wherein said pixel electrode main line is formed over said isolation layer and lays over said common electrode main line.

9. The method as claimed in claim 7, wherein at least one gate line is formed simultaneously in the step of forming said common electrode main line and said common electrodes.

10. The method as claimed in claim 7, wherein at least one data line is formed simultaneously in the step of forming said pixel electrode main line and said pixel electrode.

11. The method as claimed in claim 7, wherein in the step of forming said common electrode main line and said common electrodes, said common electrode main line is arranged along a first direction and said common electrodes are arranged in parallel along a second direction not parallel with said first direction; and in the step of forming said pixel electrode main line and said pixel electrodes, said pixel electrode main line is arranged along said first direction and lays over said common electrodes, and said pixel electrode is arranged along said second direction and overlaps said common electrodes.

12. The method as claimed in claim 7, wherein the area of every said pixel electrode is greater than that of every said common electrode covered by said pixel electrode.

13. The method as claimed in claim 7, wherein said pixel electrode and common electrode are curve-shaped.
